(19) United States
(12) Patent Application Publication
(10) Pub. No.: US 2025/0276564 A1
(43) Pub. Date: Sep. 4, 2025

(54) WINDOW ASSEMBLIES HAVING TWO OR MORE OPEN CONFIGURATIONS

(71) Applicant: Deere & Company, Moline, IL (US)

(72) Inventors: Stephen LOVAS, Dubuque, IA (US); Elizabeth MOLITOR, Dubuque, IA (US); Girish WALVEKAR, Satara (IN)

(73) Assignee: Deere & Company, Moline, IL (US)

(21) Appl. No.: 18/592,708

(22) Filed: Mar. 1, 2024

(51) Int. Cl. B60J 1/18; B60J 1/00; E05C 1/00; E05C 1/16

(52) U.S. Cl. CPC B60J 1/1861; B60J 1/007; E05C 1/004; E05C 1/16

(57) ABSTRACT

An example window assembly includes a fixed pane, a first movable pane movable between a closed position and an open position, and a second movable pane movable between a closed position and a first partially open position where at least a portion of the second movable pane is disposed over the fixed pane, between the closed position and a second partially open position where at least a portion of the second movable pane is disposed over the first movable pane, and between the closed position and the open position.

### FIELD OF THE DISCLOSURE

Example embodiments relate to window assemblies (for example, for use in vehicles, including construction vehicles, like backhoe loaders) having two or more open configurations.

### BACKGROUND

Window systems for construction or utility vehicles (such as backhoe loaders) often have an all-or-nothing approach, where the window is either fully closed or fully opened.

### SUMMARY

In various aspects, the present disclosure provides an example window assembly having two or more open configurations.

In at least one example embodiment, the window assembly includes a fixed pane, a movable pane, and a third pane, where the movable pane is at least partially movable over the fixed pane and at least partially movable over the third pane.

In at least one example embodiment, the window assembly may further include one or more latch assemblies coupled to the movable pane.

In at least one example embodiment, each of the one or more latch assemblies may include a tongue member that is movable between an extended position and a retracted position.

In at least one example embodiment, the window assembly may further include a track assembly configured to support the movable pane, where the track assembly includes a supporting portion and a locking portion. The supporting portion may be configured to receive at least a portion of the movable pane, and the locking portion may include two or more notches configured to receive the tongue member of a respective latch assembly of the one or more latch assemblies.

In at least one example embodiment, the track assembly may be a first track assembly, and the window assembly may further include a second track assembly configured to receive at least a portion of the fixed pane.

In at least one example embodiment, the movable pane may be a first movable pane and the third pane may be a second movable pane, the second movable pane may be movable between a first position and an overhead position.

In at least one example embodiment, the first movable pane may be moveable over the second movable pane and into the overhead position with the second movable pane.

In at least one example embodiment, the window assembly may further include one or more latch assemblies in association with the second movable pane.

In at least one example embodiment, each of the one or more latch assemblies may include a tongue member that is movable between an extended position and a retracted position.

In at least one example embodiment, the window assembly may further include a track assembly configured to support the second movable pane, where the track assembly includes a supporting portion and a locking portion. The supporting portion may be configured to receive at least a portion of the second movable pane, and the locking portion may include one or more notches configured to receive the respective tongue member of the respective latch assembly of the one or more latch assemblies.

In various aspects, the present disclosure provides another example window assembly having two or more open configurations.

In at least one example embodiment, the window assembly includes a fixed pane, a first movable pane movable between a closed position and an open position, and a second movable pane movable between a closed position and a first partially open position where at least a portion of the second movable pane is disposed over the fixed pane, between the closed position and a second partially open position where at least a portion of the second movable pane is disposed over the first movable pane, and between the closed position and the open position.

In at least one example embodiment, the window assembly may further include one or more latch assemblies associated with the first movable pane.

In at least one example embodiment, the each of the one or more latch assemblies may include a tongue member that is movable between an extended position and a retracted position.

In at least one example embodiment, the window assembly may further include a track assembly configured to support the first movable pane, where the track assembly itself may be configured to move between the closed position of the first movable pane to the open position of the first movable pane.

In at least one example embodiment, the window assembly may further include one or more latch assemblies coupled to the second movable pane.

In at least one example embodiment, the each of the one or more latch assemblies may include a tongue member that is movable between an extended position and a retracted position.

In at least one example embodiment, the window assembly may further includes a track assembly configured to support the second movable pane, where the track assembly includes a supporting portion and a locking portion The supporting portion may be configured to receive at least a portion of the second movable pane, and the locking portion may include one or more first notches corresponding with the closed position, one or more second notches corresponding with the first partially open position, one or more third notches corresponding with the second partially open position, and one or more fourth notches corresponding with the open position, where each notch of the one or more first notches, of the one or more second notches, of the one or more third notches, and of the one or more fourth notches is configured to receive the respective tongue member of the one or more latch assemblies.

In various aspects, the present disclosure provides another example window assembly having two or more open configurations.

In at least one example embodiment, the window assembly may include a fixed pane, a first pane assembly, and a second pane assembly. The first pane assembly may include a first movable pane that is movable between a closed position and an overhead position, a first latch assembly associated with the first movable pane, and a first track assembly configured itself to move between the closed position of the first movable pane to the overhead position of the first movable pane. The second pane assembly may include a second movable pane that is movable between a closed position and a first partially open position where at least a part of the second movable pane is disposed over a portion of the fixed pane, between the closed position and a second partially open position where at least a part of the second movable pane is disposed over a portion of the fixed movable pane, and between the closed position and the overhead position. The second pane assembly may also include a second latch assembly coupled to the second movable pane and a second track assembly. The second track assembly may include a supporting portion configured to receive at least a portion of the second movable pane and a locking portion including four or more notches configured to receive a portion of the second latch assembly.

In at least one example embodiment, a strut may enable the movement of the first track assembly between the closed position of the first movable pane and the overhead position of the first movable pane.

In at least one example embodiment, the second latch assembly may include a tongue member that is movable between an extended position and a retracted position, and the four or more notches may be configured to receive at least a portion of the tongue member.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For the purposes of clarity, various dimensions of the drawings may have been exaggerated.

FIG. 1 is a perspective view of an example vehicle having a window assembly that includes three panes (where two of the three panes are moveable a track assembly and the remaining pane of the three panes is fixed) and four latch assemblies in accordance with at least one example embodiment of the present disclosure.

FIG. 2 is an interior view of the window assembly as illustrated in FIG. 1, where the window assembly is in a fully closed state in accordance with at least one example embodiment of the present disclosure.

FIG. 3A is a perspective view of an example latch assembly that may be used as one or more of the latch assemblies of the window assembly as illustrated in FIG. 2 in accordance with at least one example embodiment of the present disclosure.

FIG. 3B is a partial exploded view of the example latch assembly illustrated in FIG. 3A in accordance with at least one example embodiment of the present disclosure.

FIG. 4 is a perspective view of the track assembly of the window assembly as illustrated in FIG. 2, where the track assembly includes a first and second movable tracks and a third fixed track, the first and second movable tracks including a plurality of notches configured to interact with the latch assemblies in accordance with at least one example embodiment of the present disclosure.

FIG. 4A is a perspective view of a first portion of the track assembly of FIG. 4 in accordance with at least one example embodiment of the present disclosure.

FIG. 4B is a perspective view of a second portion of the track assembly of FIG. 4 in accordance with at least one example embodiment of the present disclosure.

FIG. 4C is a perspective view of a third portion of the track assembly of FIG. 4 in accordance with at least one example embodiment of the present disclosure.

FIG. 5A is an interior view of the window assembly as illustrated in FIG. 2, where the movable, middle pane and the movable, top pane are stored in an overhead position, and the window is in a fully open state in accordance with at least one example embodiment of the present disclosure.

FIG. 5B is a perspective view of the window assembly as illustrated in FIG. 5A, where the movable, middle pane and the movable, top pane are stored in an overhead position, and the window is in a fully open state in accordance with at least one example embodiment of the present disclosure.

FIG. 6 is an interior view of the window assembly as illustrated in FIG. 2, where at least part of the movable, middle pane is stored over at least part of a fixed, bottom pane, and the window is in a (first) partially open state in accordance with at least one example embodiment of the present disclosure.

FIG. 7 is a cross-sectional view of the window assembly, and more specifically, the second track assembly supporting the movable, middle pane as illustrated in FIG. 6, in accordance with at least one example embodiment of the present disclosure.

FIG. 8 is an interior view of the window assembly as illustrated in FIG. 2, where at least part of a movable, middle pane of the three panes is stored over a movable, top pane of the three panes, and the window is in a (second) partially open state in accordance with at least one example embodiment of the present disclosure.

FIG. 9 is a cross-sectional view of the window assembly, and more specifically, the second track assembly supporting the movable, middle pane as illustrated in FIG. 8, in accordance with at least one example embodiment of the present disclosure.

FIG. 10A is an interior view of the window assembly as illustrated in FIG. 2, where at least part of the movable, top pane is stored overhead, and the window is in a (third) partially open state in accordance with at least one example embodiment of the present disclosure.

FIG. 10B is a perspective view of the window assembly as illustrated in FIG. 10A, where at least part of the movable, top pane is stored overhead, and the window is in a (third) partially open state in accordance with at least one example embodiment of the present disclosure.

FIG. 11 is a view of the window assembly as illustrated in FIG. 1, where at least part of the movable, top pane is stored overhead and at least part of the movable, middle pane is stored over a fixed, bottom pane, and the window is in a (fourth) partially open state in accordance with at least one example embodiment of the present disclosure.

### DETAILED DESCRIPTION

Some detailed example embodiments are disclosed herein. However, specific structural and functional details disclosed herein are merely representative for the purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, component, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” specify the presence of stated features, integers, steps, operations, and/or elements, but do not preclude the presence or addition of one or more other features, integers, steps, operations, elements, and/or groups thereof.

When the terms “about” or “substantially” are used in this specification in connection with a numerical value, it is intended that the associated numerical value includes a manufacturing or operational tolerance (e.g., +10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

At least some example embodiments of the present disclosure provide window assemblies (for example, for use in vehicles, including construction vehicles, like backhoe loaders) having two or more open configurations.

As used herein, vehicle may include, for example, an automotive vehicle and/or an agricultural vehicle and/or a mining vehicle and/or a construction vehicle and/or a utility vehicle. The vehicle may include, for example, backhoe loaders, tractors, planters, sprayers, bulldozers, forklifts, steam rollers, cranes, haul truck, underground graders, rock breakers, and the like.

Window systems for construction or utility vehicles (such as backhoe loaders) often have an all-or-nothing approach, where the window is either fully closed or fully opened, offering the user limited options during inclement weather. The present disclosure provides window assemblies having one or more venting positions.

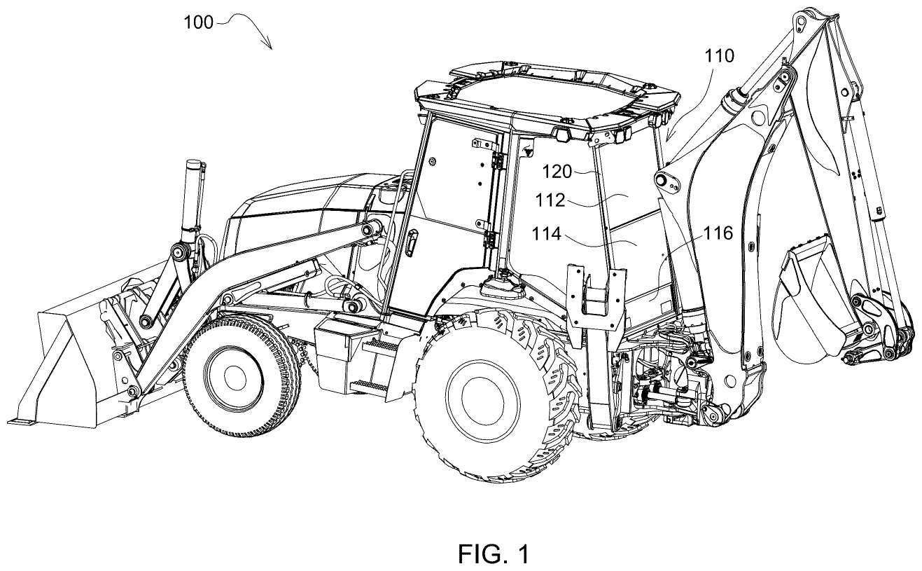

FIG. 1 is a perspective view of an example vehicle 100 including a window assembly 110 in accordance with at least one example embodiment of the present disclosure. The window assembly 110 includes a track (or rail) assembly 120 configured to support two movable panes (or panels) 112, 114 and a single fixed pane (or panel) 116. The panes 112, 114, 116 may be transparent, translucent, or opaque.

Although the vehicle 100 is illustrated as including only a single window assembly 110, it should be appreciated that, in other example embodiments, vehicles may include two or more window assemblies. Further, although three panes are illustrated, it should be appreciated that, in other example embodiments, window assemblies may include only two panes where the two panes are moveable over a stationary structure (or component), or in yet other example embodiments, four or more panes where at least two of the panes are movable.

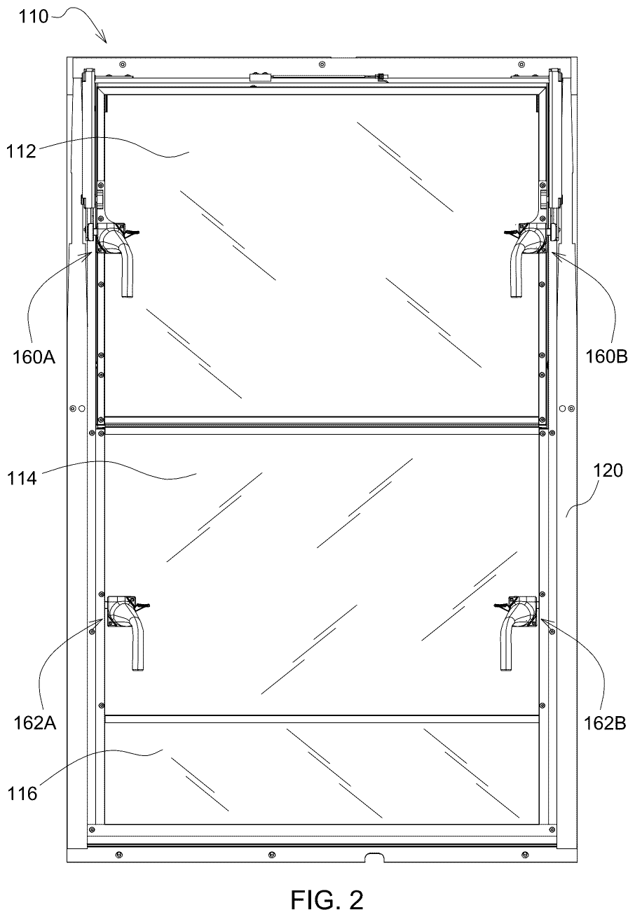

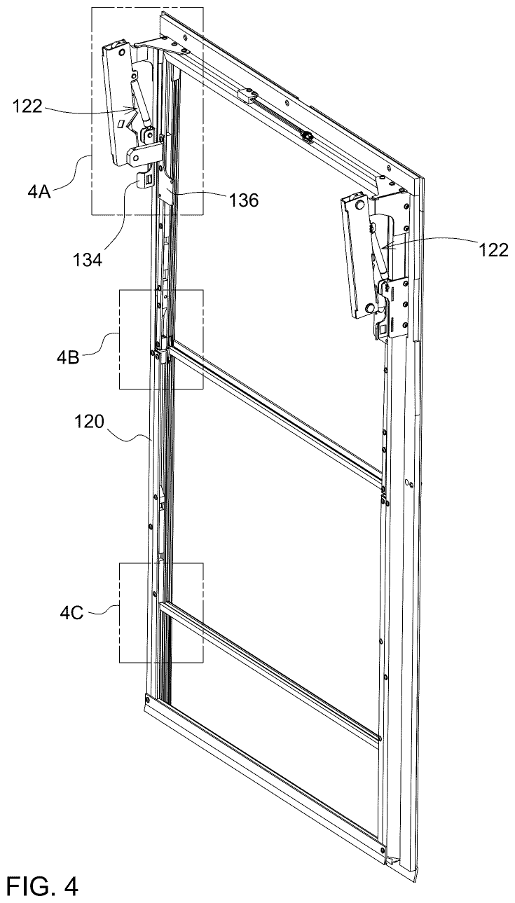

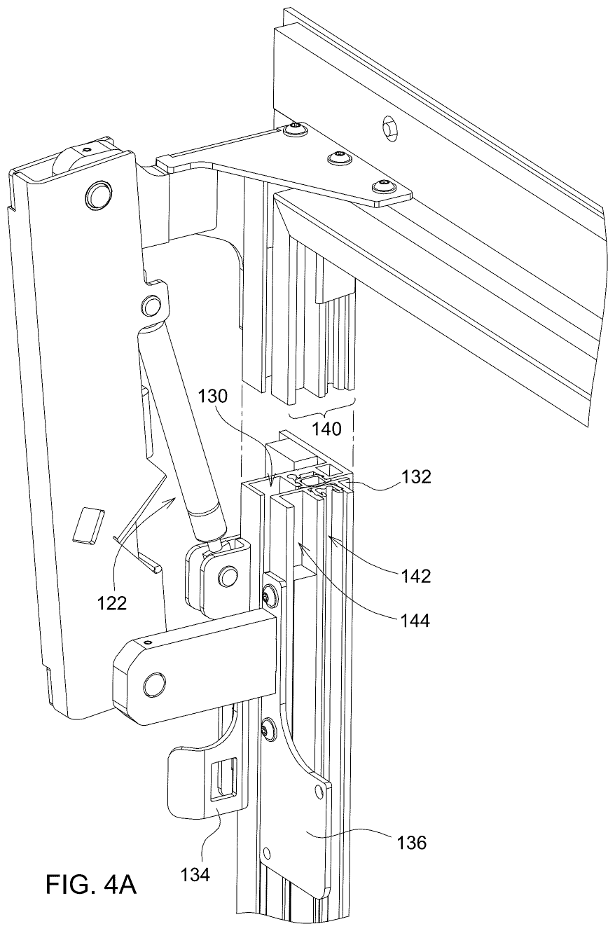

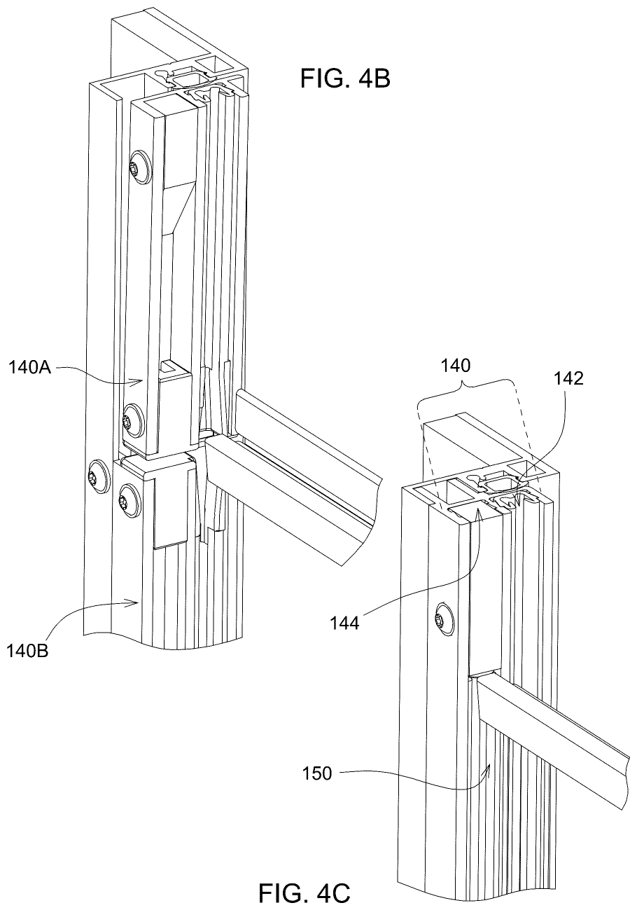

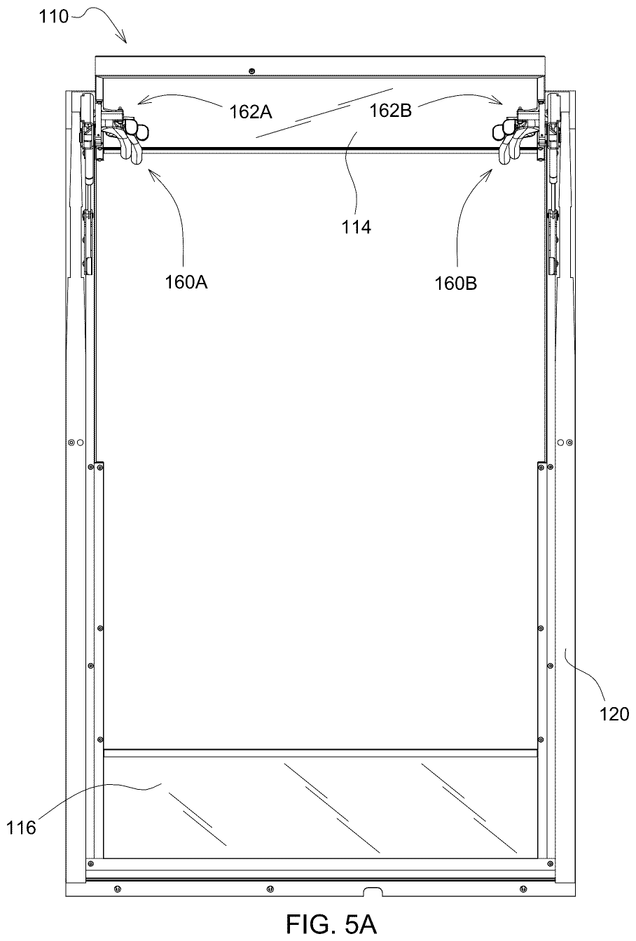

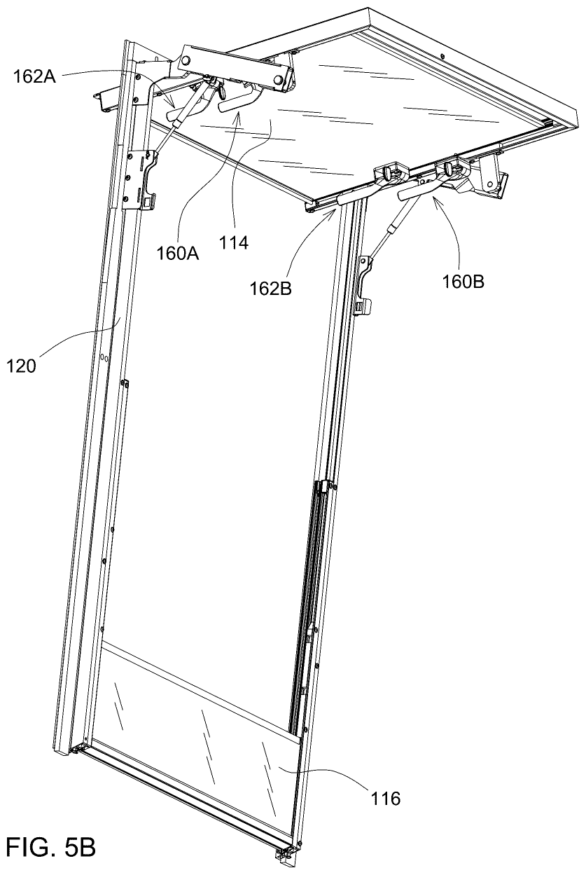

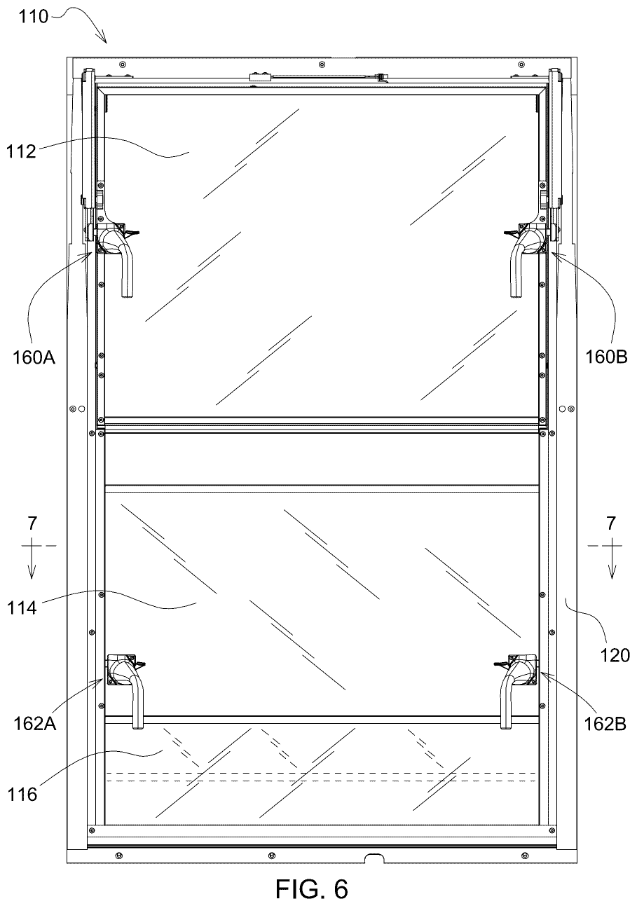

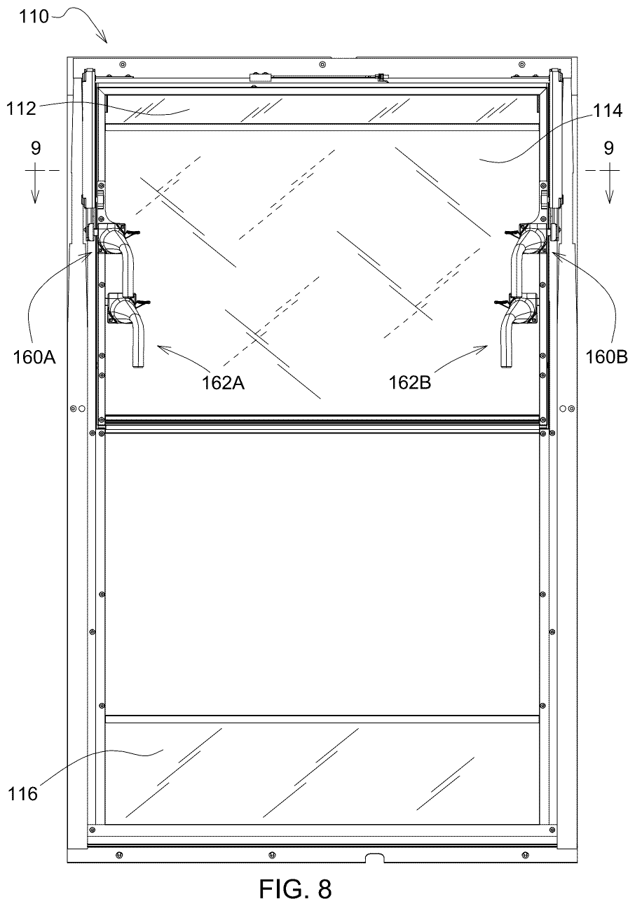

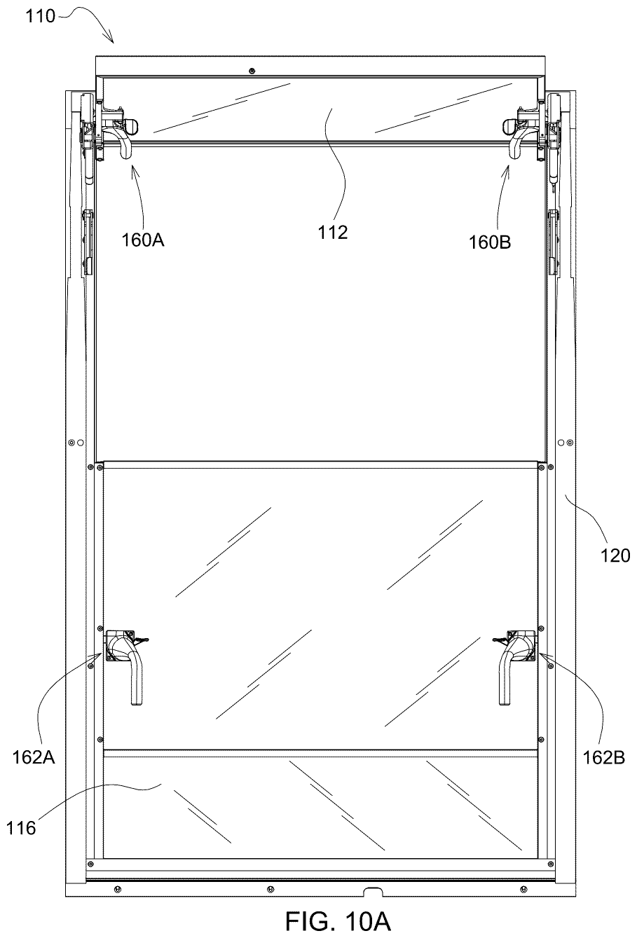

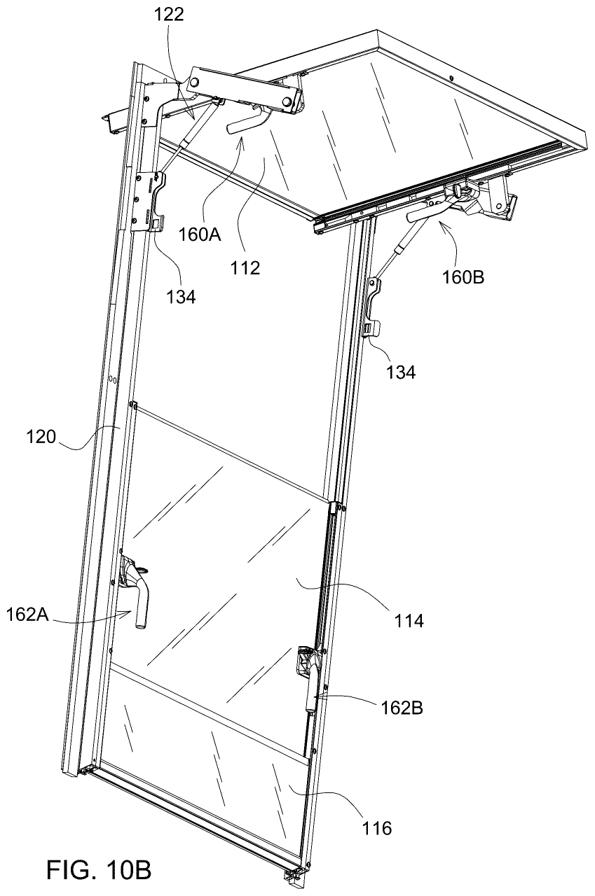

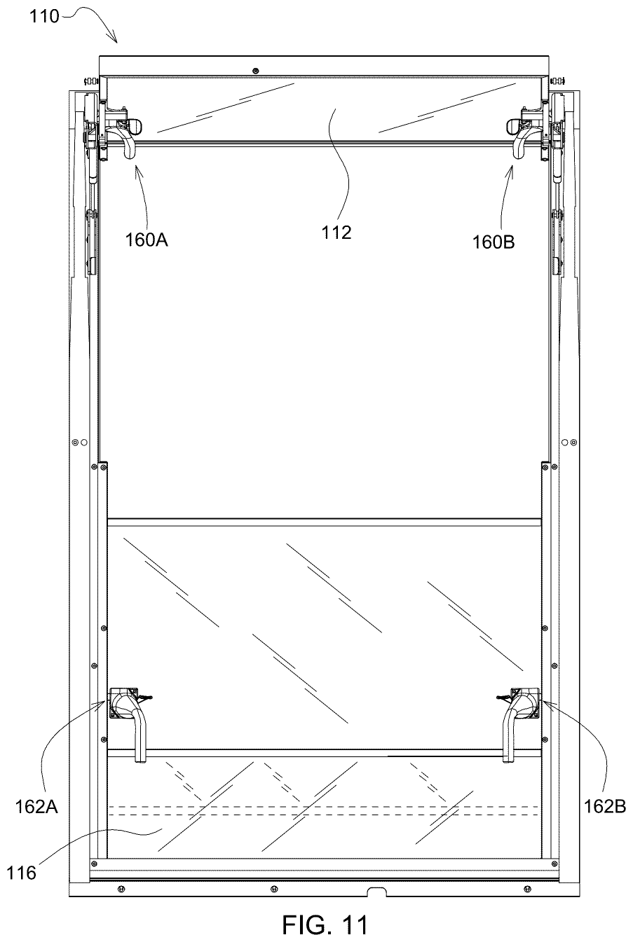

FIG. 2 is a view of the window assembly 110 in a fully closed state in accordance with at least one example embodiment of the present disclosure. As illustrated, the window assembly 110 has three panes, including a top (or first) pane 112, a middle (or second) pane 114, and a bottom (or third) pane 116, where in a closed position (as illustrated in FIGS. 1 and 2), the middle pane 114 is disposed between the top pane 112 and the bottom plane 116. The top pane 112 and the middle pane 114 are movable panes, while the bottom pane 116 is a fixed pane. For example, the top pane 112 may move (for example, along a first track 130 of the track assembly 120 as illustrated in FIG. 4) from a first (or closed) position (as illustrated in FIGS. 1 and 2) to second (or open or overhead) position (as illustrated in FIGS. 5 and 10), as further discussed below. The middle pane 114 may move (for example, along a second track 140 of the track assembly 120 as illustrated in FIG. 4) from a closed position (as illustrated in FIGS. 1 and 2) to a first open position where the middle pane 114 is stored overhead with the top pane 112 (as illustrated in FIGS. 5A and 5B) and/or to a second open position where at least a portion of the middle pane 114 is stored over (in front of or behind) at least a portion of the top pane 112 (as illustrated in FIG. 8) and/or to a third open position where at least a portion of the middle pane 114 is stored over (in front of or behind) at least a portion of the bottom pane 116 (as illustrated in FIGS. 6 and 11), each of which being further discussed below. Although the top and second panes 112, 114 are described as movable panes and the bottom pane 116 is described as a fixed pane, it should be appreciated that, in various other embodiments, the bottom and middle panes may be movable panes while the top pane is a fixed pane.

With renewed reference to FIG. 2, the window assembly 110 includes two or more latching (or locking) assemblies 160A, 160B, 162A, 162B. For example, as illustrated, in at least one example embodiment, the window assembly 110 includes four latching assemblies 160A, 160B, 162A, 162B (or two sets of latching assemblies), where two of the four latching assemblies are (or a first pair of the two sets of latching assemblies is) associated with the movable, top pane 112 and two of the four latching assemblies are (or a second pair of the latching assemblies is) associated with the movable, middle pane 114. Although the top pane 112 is illustrated as including two latching assemblies (or a pair of latch assemblies) 160A, 160B it should be appreciated that, in various other embodiments, the top pane 112 may be associated with a single latch assembly, or alternatively still, three or more latch assemblies. Although the middle pane 114 is illustrated as including two latching assemblies (or a pair of latch assemblies) 160A, 160B, it should be appreciated that, in various other embodiments, the middle plane 114 may be associated with a single latch assembly, or alternatively still, three or more latch assemblies. In at least one example embodiment, each of the latch assemblies 160A, 160B, 162A, 162B may be the same type having the same configuration.

The latch assemblies 160A, 160B may be disposed along a perimeter of the top pane 112. For example, in at least one example embodiment, as illustrated, the first and second latch assemblies 160A, 160B of the top pane 112 may be associated with opposing sides of the top pane 112. In at least one example embodiment, as illustrated, the top pane 112 may have a general rectangular shape and the latch assemblies 160A, 160B may be associated with the opposing shorter (or smaller) lengths of the rectangular shape. In at least one example embodiment, as illustrated, the latch assemblies 160A, 160B may be disposed nearer to a middle point of the respective side than to the starting (or first) end and an ending (or second) end of the respective side.

The latch assemblies 162A, 162B may be disposed along a perimeter of the middle pane 114. For example, in at least one example embodiment, as illustrated, the first and second latch assemblies 162A, 162B of the middle pane 114 may be associated with opposing sides of the middle pane 114. In at least one example embodiment, as illustrated, the middle pane may have a general rectangular shape and the latch assemblies 162A, 162B may be associated with the opposing shorter (or smaller) lengths of the rectangular shape. In at least one example embodiment, as illustrated, the latch assemblies 162A, 162B may be disposed nearer to a middle point of the respective side than to the starting (or first) end and an ending (or second) end of the respective side.

Although the top pane 112, the middle pane 114, and the bottom pane 116 are illustrated as each having a general rectangular shape, it should be appreciated that, in other example embodiments, the top pane 112 and/or the middle pane 114 and/or the bottom pane 116 may take the form of one or more other shapes.

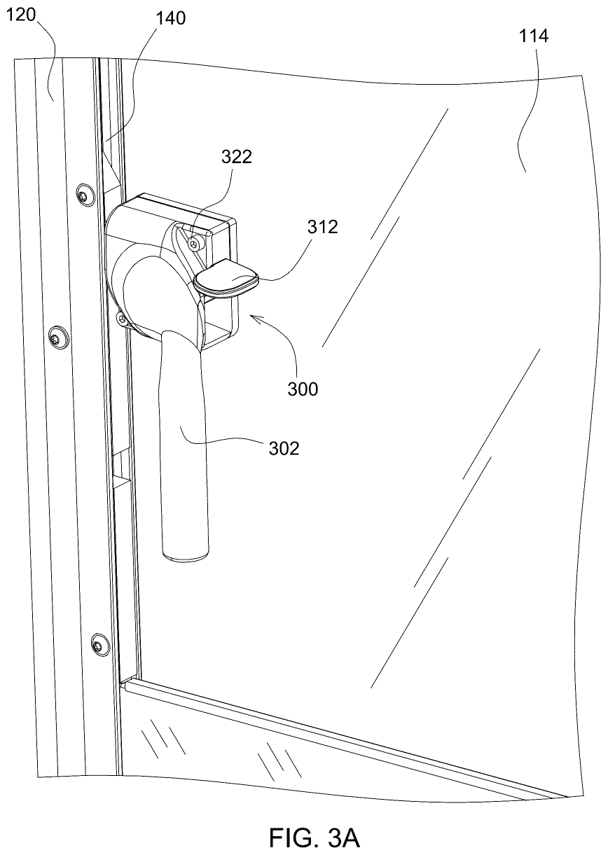

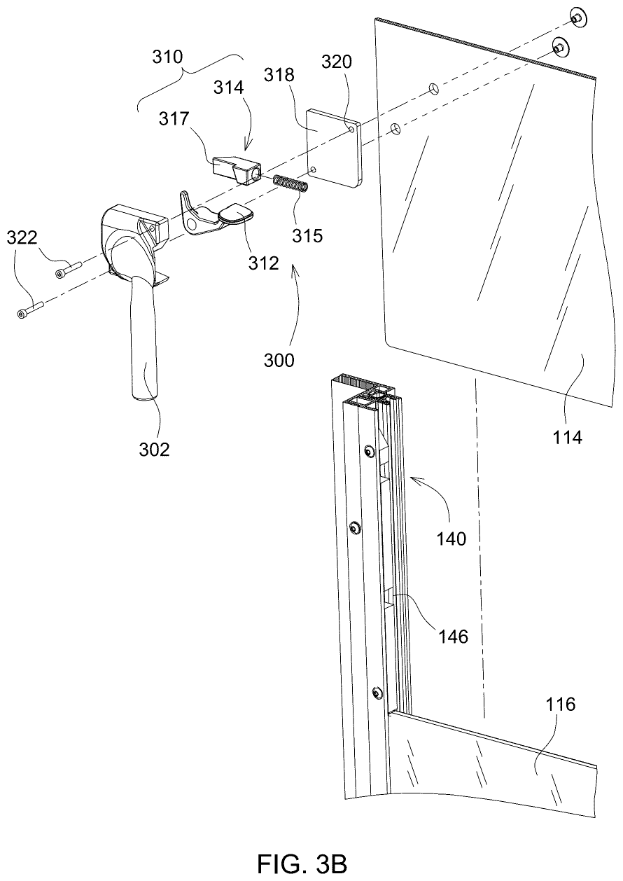

FIG. 3A is a perspective view of an example latch assembly 300 that may be used as one or more of the latch assemblies 160A, 160B, 162A, 162B, and FIG. 3B is a partial exploded view of the window assembly 110 including the example latch assembly 300.

The latch assembly 300 includes a handle (or gripping member) 302 and a locking mechanism 310. In at least one example embodiment, the locking mechanism 310 includes, for example, a trigger 312 in communication with a tongue member 314 such that activation of the trigger 312 may cause the tongue member 314 to move between a first (or extended) position and a second (or retracted) position. In at least one example embodiment, the tongue member 314 may be a spring-loaded mechanism (see spring 315) and may have at least a portion 317 shaped to be received within one or more portions of the track assembly 120. For example, as illustrated, the tongue member 314 may be shaped to be received within the notches 146 of the second track 140 of the track assembly 120 that are configured to hold the movable, middle pane 114 in selected positions. Although not specifically illustrated in FIGS. 3A and 3B, it should be appreciated that the tongue member 314 may be shaped (additionally or alternatively) to be received the notches 134 of the first track 130 of the track assembly 120 that are configured to hold the movable, top pane 112 in selected positions.

In at least one example embodiment, the latch assembly 300 may further includes a plate or main body 318 having one or more apertures 320 configured to receive one or more coupling members 322, for example, for joining the latch assembly 300 to the different panes (e.g., the middle pane 114 as illustrated in FIGS. 3A and 3B), as illustrated. In at least one example embodiment, as illustrated in FIG. 3B, the coupling members 322 may each include a first portion and a second portion, where the first portion protrudes (or extends) through the handle 302, the main body 318, the middle pane 114 and joins to the second portion on another side of the middle pane 114.

Although not specifically illustrated in FIGS. 3A and 3B, it should be appreciated that the main body 318 and coupling members 322 may be similarly used to secure the latch assembly 300 to the receiving plate 136 of the first track 130. Although the latch assembly 300 is illustrated as including two apertures 320, it should be appreciated that, in various example embodiments, the latch assembly 300 may include a single aperture or three or more apertures. Further still, it should be appreciated that, in various example embodiments, the latch assembly 320 may be an integrally formed member, for example, formed as an integral member with a pane member (e.g., the middle pane 114) or a receiving plate (e.g., the receiving plate 136 of the first track 130).

FIG. 4 is a perspective view of the track assembly 120, while FIG. 4A is a perspective view of a first portion of the track assembly 120, FIG. 4B is a perspective view of a second portion of the track assembly 120, and FIG. 4C is a perspective view of a third portion of the track assembly 120. As illustrated, the track assembly 120 includes three tracks (or rails), including a first track (or rail) 130 configured to support the top pane 112, a second track (or rail) 140 configured to support (the middle pane 114, and a third track (or rail) 150 configured to support the bottom pane 116.

The first track 130 may extend, for example, along only a top (or first) portion (or end) 124 of the track assembly 120 (or window assembly 110). The first track 130 may have a linear shape that is continuous or discontinuous.

In at least one example embodiment, the first track 130 (e.g., a supporting portion 132 of the first track 130) supports the top pane 112 by receiving at least a portion of the top pane 112. In at least one example embodiment, the first track 130 supports the top pane 112 by being formed integrally with the top pane 112. In at least one example embodiment, the first track 130 supports the top pane 112 by being couplable one or more portions of the top pane 112.

The second track 140 may extend, for example, along an entire length of the track assembly 120 (or window assembly 110). The second track 140 may have a linear shape that is continuous or discontinuous. For example, as illustrated, in at least one example embodiment, the second track 140 may be discontinuous so as to allow a first portion (or half) 140A of the second track 140 to secure the top pane 112 and/or the middle pane 114 in the overhead position (see FIGS. 5A, 5B, 10A, 10B, and 11) and the second portion (or half) 140B of the second track 140 to secure the middle pane 114 in a closed position for the middle pane 114. In at least one example embodiment, the first track 130 may be joined to or joinable to the first portion 140A of the second track 140.

In at least one example embodiment, the second track 140 (e.g., a supporting portion 142 of the second track 140) supports the middle pane 114 by receiving at least a portion of the middle pane 114. In at least one example embodiment, the second track 140 supports the middle pane 114 by being formed integrally with the middle pane 114. In at least one example embodiment, the second track 140 supports the middle pane 114 by being couplable one or more portions of the middle pane 114.

The third track 150 may extend, for example, along a bottom (or second) portion (or end) 126 of the track assembly 120 (or window assembly 110) that opposes the top portion 124. The third track 150 may have a linear shape that is continuous or discontinuous.

In at least one example embodiment, the third track 150 supports the bottom pane 116 by receiving at least a portion of the bottom pane 116. In at least one example embodiment, the third track 150 supports the bottom pane 116 by being formed integrally with the bottom pane 116. In at least one example embodiment, the third track 150 supports the bottom pane 116 by being couplable one or more portions of the bottom pane 116.

In at least one example embodiment, the third track 150 is configured to fixedly secure the bottom pane 116, while the first and second tracks 130, 140 are configured to allow for movement of the top and middle panes 112, 114, respectively.

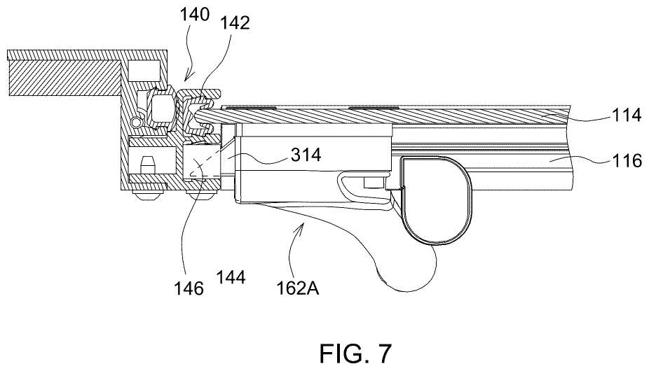

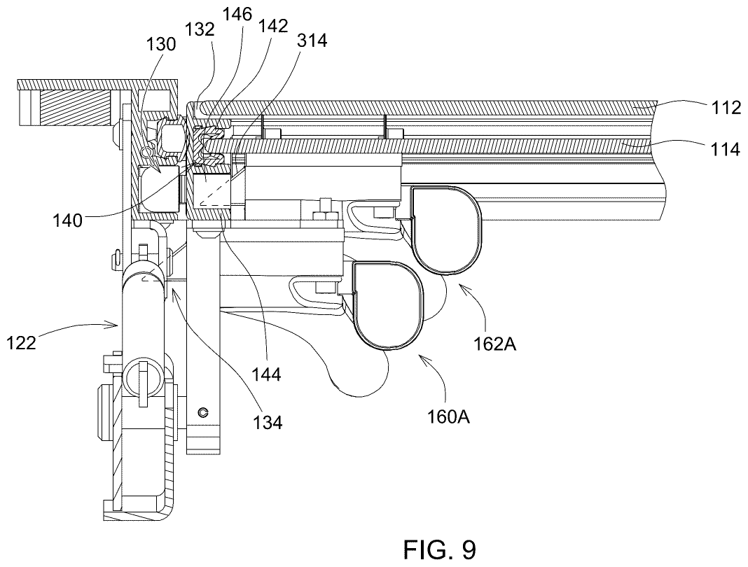

As illustrated, for example, in FIGS. 4 and 4A-4C (and also FIGS. 7 and 9 as discussed below), the second track 140 may include a supporting portion 142 and a locking portion 144, where the supporting portion 142 supports of the middle pane 114 and the (second) locking portion 144 includes a (second) plurality of notches 146 configured (e.g., shaped) to receive a tongue member of respective latch assemblies 162A, 162B. When the respective tongue member is (or tongue members are) retracted, for example, using a trigger assembly of the respective latch assembly, the corresponding pane (i.e., the middle pane 114) may be released and made movable.

In at least one example embodiment, the middle pane 114 may be repositioned, for example, in an overhead position with the top pane 112, as illustrated in FIGS. 5A and 5B. In at least one example embodiment, the middle pane 114 may be repositioned, for example, in a (first) partially open or vent state, as illustrated in FIG. 6. In at least one example embodiment, the middle pane 114 may be repositioned, for example, in a (second) partially open or vent state, as illustrated in FIG. 8. In at least one example embodiment, the middle pane 114 may be repositioned, for example, in a (fourth) partially open or vent state, as illustrated in FIG. 11. That is, in at least one example embodiment, the middle pane 114 is movable between a closed position for the middle pane 114 (see FIGS. 1, 2, 10A, and 10B) and three open positions (see FIGS. 5A and 5B illustrate a first open position for the middle pane 114, FIGS. 6 and 11 illustrates a second open position for the middle pane 114, FIG. 8 illustrates a third open position for the middle pane 114).

In at least one example embodiment, the middle pane 114 may be placed in the overhead position with the top pane, as illustrated in FIGS. 5A and 5B, from the closed position for the middle pane 114 by retracting the respective tongue members of the latch assemblies 162A, 162B and applying an upward force such that the middle pane moves (i.e., slides) over the top pane 116 and then releasing the a top portion of the second track 140 by retracting the tongue members of the latch assemblies 160A, 160B to allow the top portion of the second track 140 with the top pane 112 and the middle pane 114 to move (e.g., swings or pivots) into the overhead position.

In at least one example embodiment, the middle pane 114 may be slid within the second track 140 between the closed position for the middle pane 114 and the (first) partially open or vent state, as illustrated in FIG. 6, by retracting the respective tongue members of the latch assemblies 162A, 162B and applying a downward force such that the middle pane 114 moves (i.e., slides) behind the bottom pane 116. The respective tongue members of the latch assemblies 162A, 162B may be released and extended to interface with one or more notches 146 to secure the middle pane 114 in the (first) partially open or vent state.

In at least one example embodiment, the middle pane 114 may be slid within the second track 140 between the closed position for the middle pane 114 and the (second) partially open or vent state, as illustrated in FIG. 8, by retracting the respective tongue members of the latch assemblies 162A, 162B and applying an upward force such that the middle pane moves (i.e., slides) over the top pane 116. The respective tongue members of the latch assemblies 162A, 162B may be released and extended to interface with one or more notches 146 to secure the middle pane 114 in the (second) partially open or vent state.

As illustrated, for example, in FIGS. 4 and 4A-4C (and also FIGS. 7 and 9 as discussed below), the first track 130 may include a supporting portion 132 that supports (or receives at least a portion) of the top pane 112. The first track 130 may further include a notch structure 134 configured (e.g., shaped) to receive a tongue member of respective latch assemblies 160A, 160B. When the respective tongue member is (or tongue members are) retracted, for example, using a trigger assembly of the respective latch assembly, the corresponding pane (i.e., the top pane 112) may be released and made movable. In at least one example embodiment, the top pane 112 may be repositioned, for example, in an overhead position, as illustrated in FIGS. 5A, 5B, 10A, 10B, and 11. That is, in at least one example embodiment, the top pane 112 is movable between a closed position for the top pane 112 (see FIGS. 1, 2, 6, and 8) and an open position for the top pane 112 (see FIGS. 5A, 5B, 10A, 10B, and 11). The top pane 112 may be secured in the overhead position by one or more struts 122 and/or by releasing the tongue member of respective latch assemblies 160A, 160B to be received within corresponding notches (or like cavities) (not shown). In at least one example embodiment, as mentioned above, the first track 130 and/or a top portion 140B of the second track 140 may also move into the overhead position to secure the top pane 112 and/or middle pane 114 in the overhead position.

In at least one example embodiment, the top pane 112 may be placed in the overhead position, as illustrated in FIGS. 5A, 5B, 10A, 10B, and 11, from the closed position for the top pane 112 by retracting the tongue members of the latch assemblies 160A, 160B to allow the top portion of the second track 140 with the top pane 112 to move (e.g., swings or pivots) into the overhead position.

FIG. 5A is a view of the window assembly 110 in a fully open state in accordance with at least one example embodiment of the present disclosure. FIG. 5B is a perspective view of the window assembly 110 in the fully open state in accordance with at least one example embodiment of the present disclosure. As illustrated, in the fully open state, the middle pane 114 and the top pane 114 are together disposed in the overhead position. In at least one example embodiment, a method for placing the window assembly 110 in the fully open state may include first placing (or securing) the middle pane 114 behind top pane 114 (for example, as illustrated in FIG. 8) and then placing (or securing) the middle pane 114 and the top pane 112 in the overhead position. In at least one example embodiment, the frame 120 may include one or more struts 122 (e.g., gas struts) that assists with and secure the overhead positioning.

FIG. 6 is a view of the window assembly 110 in a (first) partially open state in accordance with at least one example embodiment of the present disclosure. As illustrated, in the (first) partially open or vent state, at least part of the middle pane 114 may be stored over (in front of or behind) at least part of the bottom pane 116.

FIG. 7 is a cross-sectional view of the window assembly 110 where the window assembly 110 is in the (first) partially open or vent state and at least part of the middle pane 114 is stored over (in front of or behind) at least part of the bottom pane 116. As illustrated, the middle pane 114 is supported by a supporting portion 142 and a tongue 314 of the respective latch assembly 162A is received by a notch 146 in the (second) locking portion 144 to secure the middle pane 114 in the (first) partially open or vent state.

FIG. 8 is a view of the window assembly 110 in a (second) partially open state in accordance with at least one example embodiment of the present disclosure. As illustrated, in the (second) partially open or vent state, at least part of the middle pane 114 may be stored over (in front of or behind) at least part of the top pane 112.

FIG. 9 is a cross-sectional view of the window assembly 110 is in the (second) partially open or vent state and at least part of the middle pane 114 is stored over (in front of or behind) at least part of the top pane 112. As illustrated, the middle pane 114 is supported by a supporting portion 142 and a tongue of the respective latch assembly 162A is received by a notch 146 in the (second) locking portion 144 to secure the middle pane 114 in the (second) partially open or vent state.

FIG. 10A is a view of the window assembly 110 in a (third) partially open state in accordance with at least one example embodiment of the present disclosure; and FIG. 10B is a perspective view of the window assembly 110 in a (third) partially open state in accordance with at least one example embodiment of the present disclosure. As illustrated, in the (third) partially open or vent state, at least part of the top pane 112 is stored overhead.

FIG. 11 is a view of the window assembly 110 in a (fourth) partially open state in accordance with at least one example embodiment of the present disclosure. As illustrated, in the (fourth) partially open or vent state, at least part of the middle pane 114 may be stored over (in front of or behind) at least part of the bottom pane 116 and at least part of the top pane 112 is stored overhead.

While some example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

Although described with reference to specific examples and drawings, modifications, additions, and substitutions of example embodiments may be variously made according to the description by those of ordinary skill in the art. For example, the described techniques may be performed in an order different with that of the methods described, and/or elements such as the described system, architecture, devices, circuit, and the like, may be connected or combined to be different from the above-described methods, or results may be appropriately achieved by other elements or equivalents.

1. A window assembly having two or more open configurations and comprising:
a fixed pane;
a movable pane; and
a third pane, the movable pane being at least partially movable over the fixed pane and at least partially movable over the third pane.

2. The window assembly of claim 1, wherein the window assembly further includes:
one or more latch assemblies coupled to the movable pane.

3. The window assembly of claim 2, wherein each of the one or more latch assemblies includes a tongue member that is movable between an extended position and a retracted position.

4. The window assembly of claim 3, wherein the window assembly further includes:
a track assembly configured to support the movable pane, the track assembly including a supporting portion and a locking portion, the supporting portion configured to receive at least a portion of the movable pane, and the locking portion including two or more notches configured to receive the tongue member of a respective latch assembly of the one or more latch assemblies.

5. The window assembly of claim 4, wherein the track assembly is a first track assembly, and the window assembly further includes:
a second track assembly configured to receive at least a portion of the fixed pane.

6. The window assembly of claim 1, wherein the movable pane is a first movable pane, and the third pane is a second movable pane, the second movable pane movable between a first position and an overhead position.

7. The window assembly of claim 6, wherein the first movable pane is moveable over the second movable pane and into the overhead position with the second movable pane.

8. The window assembly of claim 6, wherein the window assembly further includes:
one or more latch assemblies in association with the second movable pane.

9. The window assembly of claim 8, wherein each of the one or more latch assemblies includes a tongue member that is movable between an extended position and a retracted position.

10. The window assembly of claim 9, wherein the window assembly further includes:
a track assembly configured to support the second movable pane, the track assembly including a supporting portion and a locking portion, the supporting portion configured to receive at least a portion of the second movable pane, and the locking portion including one or more notches configured to receive the respective tongue member of a respective latch assembly of the one or more latch assemblies.

11. A window assembly having two or more open configurations and comprising:
a fixed pane;
a first movable pane movable between a closed position and an open position; and
a second movable pane movable between a closed position and a first partially open position where at least a portion of the second movable pane is disposed over the fixed pane, between the closed position and a second partially open position where at least a portion of the second movable pane is disposed over the first movable pane, and between the closed position and the open position.

12. The window assembly of claim 11, wherein the window assembly further includes:
one or more latch assemblies associated with the first movable pane.

13. The window assembly of claim 12, wherein the each of the one or more latch assemblies includes a tongue member that is movable between an extended position and a retracted position.

14. The window assembly of claim 13, wherein the window assembly further includes:
a track assembly configured to support the first movable pane, the track assembly configured to move between the closed position of the first movable pane to the open position of the first movable pane.

15. The window assembly of claim 11, wherein the window assembly further includes:
one or more latch assemblies coupled to the second movable pane.

16. The window assembly of claim 15, wherein the each of the one or more latch assemblies includes a tongue member that is movable between an extended position and a retracted position.

17. The window assembly of claim 16, wherein the window assembly further includes:
a track assembly configured to support the second movable pane, the track assembly including a supporting portion and a locking portion, the supporting portion configured to receive at least a portion of the second movable pane, and the locking portion including one or more first notches corresponding with the closed position, one or more second notches corresponding with the first partially open position, one or more third notches corresponding with the second partially open position, and one or more fourth notches corresponding with the open position, each notch of the one or more first notches, of the one or more second notches, of the one or more third notches, and of the one or more fourth notches is configured to receive the respective tongue member of a respective latch assembly of the one or more latch assemblies.

18. A window assembly having two or more open configurations and comprising:
a fixed pane;
a first pane assembly including
a first movable pane that is movable between a closed position and an overhead position,
a first latch assembly associated with the first movable pane, and
a first track assembly configured itself to move between the closed position of the first movable pane to the overhead position of the first movable pane; and
a second pane assembly including
a second movable pane that is movable between a closed position and a first partially open position where at least a part of the second movable pane is disposed over a portion of the fixed pane, between the closed position and a second partially open position where at least a part of the second movable pane is disposed over a portion of the first movable pane, and between the closed position and the overhead position,
a second latch assembly coupled to the second movable pane, and
a second track assembly including
a supporting portion configured to receive at least a portion of the second movable pane, and
a locking portion including four or more notches configured to receive a portion of the second latch assembly.

19. The window assembly of claim 18, wherein a strut enables movement of the first track assembly between the closed position of the first movable pane and the overhead position of the first movable pane.

20. The window assembly of claim 18, wherein the second latch assembly includes a tongue member that is movable between an extended position and a retracted position, and the four or more notches are configured to receive at least a portion of the tongue member.
